(19) United States
(12) Patent Application Publication
(10) Pub. No.: US 2026/0342090 A1
(43) Pub. Date: Oct. 29, 2026

(54) REACTIVE POWER CONTROL DEVICE AND POWER SYSTEM

(71) Applicant: Hitachi GE Vernova Nuclear Energy, Ltd., Ibaraki (JP)

(72) Inventors: Tadashi SHIMIZU, Ibaraki (JP); Yuji HOSOKAWA, Ibaraki (JP); Yohei MURAKAMI, Tokyo (JP)

(21) Appl. No.: 19/646,884

(22) Filed: Apr. 14, 2026

(30) Foreign Application Priority Data
Apr. 28, 2025 (JP) 2025-074053

(51) Int. Cl. H02J 3/1885; H02J 13/12; H02J 13/181; H02J 105/16

(52) U.S. Cl. CPC H02J 3/1885; H02J 13/12; H02J 13/181; H02J 2105/16

(57) ABSTRACT

A reactive power control device includes a receiving unit configured to receive a first voltage at a demand point at which power is received from a first voltage sensor, and a reactive power command unit configured to command a power generation source that outputs AC power to the demand point to generate reactive power based on the first voltage via a power transmission system. More preferably, the reactive power command unit is configured to command the power generation source to generate reactive power based on the first voltage and the second voltage.

### CROSS-REFERENCE TO RELATED APPLICATION

This disclosure claims the priority benefit of Japanese Patent Application No. 2025-074053 filed on Apr. 28, 2025, and the entirety of the above-mentioned patent application is hereby incorporated by reference herein and made a part of this specification.

### TECHNICAL FIELD

The present disclosure relates to a reactive power control device and a power system.

### BACKGROUND ART

In present power plants such as a nuclear power plant and a thermal power plant, the vicinity of a synchronous machine or the vicinity of a switching station is used as a reference point for voltage adjustment using the synchronous machine. On the other hand, since these power plants are often located at places away from the demand area, many voltage compensation devices are required up to the demand area. Further, a renewable energy plant, which has been increasing in recent years, is often located near a demand area, and a voltage state of the power system is becoming more complicated such as occurrence in a voltage rise at a demand point due to a reverse power flow or the like. Power plants are in a trend of requiring voltage adjustment cooperated with a renewable energy plant. It is expected that power plants also contribute to cost reduction of power transmission system facilities and voltage reliability at demand points.

As an example of the reactive power control technique, the abstract of Japanese Patent Application Publication No. 2017-153277 describes that “ [PROBLEM TO BE SOLVED] To provide a self-excited reactive power compensation apparatus capable of reducing a power loss that occurs in a self-excited converter. [SOLUTION] A self-excited reactive power compensation apparatus comprises a self-excited converter and a control device configured to control an output voltage of the self-excited converter. The self-excited converter is connected between a DC positive bus bar and a DC negative bus bar and configured to convert a DC voltage Vdc into an AC voltage Vi. The self-excited converter is configured to output advanced reactive power when the output voltage Vi is higher than a system voltage Vs and, on the other hand, output delayed reactive power when the output voltage Vi is lower than the system voltage Vs. The control device makes the DC voltage Vd in the case where the self-excited converter outputs the delayed reactive power, lower than the DC voltage Vdc in the case where the self-excited converter outputs the advanced reactive power.”

### SUMMARY OF INVENTION

In the above-described technique, there is a demand for more appropriately controlling the reactive power.

The present disclosure has been made in view of the above-described circumstances, and an object thereof is to provide a reactive power control device and a power system capable of appropriately controlling the reactive power.

In order to solve the above-described issue, a reactive power control device of the present disclosure includes a receiving unit configured to receive a first voltage at a demand point at which power is received from a first voltage sensor, and a reactive power command unit configured to command a power generation source that outputs AC power to the demand point via a power transmission system to generate reactive power based on the first voltage.

According to the present disclosure, reactive power can be controlled appropriately.

### BRIEF DESCRIPTION OF DRAWINGS

FIG. 1 is a block diagram of a power system according to a first embodiment;

FIG. 2 is a block diagram of a power system according to a second embodiment;

FIG. 3 is a block diagram of a power system 200 according to a comparative example.

### DETAILED DESCRIPTION OF INVENTION

### First Embodiment

### Configuration of First Embodiment

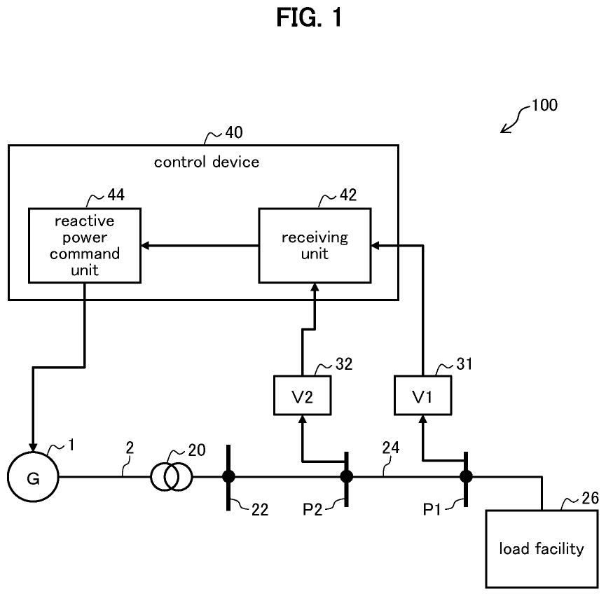

FIG. 1 is a block diagram of a power system 100 according to a first embodiment.

In FIG. 1, the power system 100 includes a synchronous machine 1 (i.e., power generation source), a main circuit 2, a transformer 20 (i.e., first transformer), a switching station 22, a power transmission system 24, a voltage sensor 31 (i.e., first voltage sensor), a voltage sensor 32 (i.e., second voltage sensor), and a control device 40 (i.e., reactive power control device). The synchronous machine 1, the main circuit 2, the transformer 20, the switching station 22, and the power transmission system 24 all output or transmit three phase power. The synchronous machine 1, the main circuit 2, and the transformer 20 are facilities provided in a power plant, and the main circuit 2 connects the synchronous machine 1 and a primary winding (no reference numeral) of the transformer 20. The switching station 22 is inserted between a secondary winding (no reference numeral) of the transformer 20 and the power transmission system 24, and performs a switching operation from the transformer 20 to the power transmission system 24.

The power transmission system 24 is connected to a load facility 26 at a demand point P1. The voltage sensor 31 measures a voltage V1 (i.e., first voltage) at the demand point P1. The voltage sensor 32 measures a voltage V2 (i.e., second voltage) at an observation point P2 located between the switching station 22 and the demand point P1. A power output from the synchronous machine 1 is supplied to the load facility 26 via the main circuit 2, the switching station 22, the observation point P2, and the demand point P1 in this order.

The control device 40 includes a receiving unit 42 and a reactive power command unit 44. The receiving unit 42 receives detection results of the voltages V1 and V2 from the voltage sensors 31 and 32. The reactive power command unit 44 controls a field current of the synchronous machine 1 based on the voltages V1 and V2, thereby controlling the reactive power generated by the synchronous machine 1. The control device 40 may be configured by a computer or may be configured by other logic circuits.

Here, a preferable value as the voltage V1 at the demand point P1 is defined as a rated voltage Vd (i.e., first level). Further, an allowable upper limit voltage determined by a facility specification of the power transmission system 24 is set as Vmax (i.e., third level), and an allowable lower limit voltage is set as Vmin (i.e., second level). The reactive power command unit 44 acquires measurement results of the voltages V1 and V2 from the receiving unit 42 in each predetermined sampling period, and determines whether or not either of the following condition C1 (i.e., first condition) or condition C2 (i.e., second condition) is satisfied.
*Condition C1: “V1<Vd” and “V2<Vmax” are satisfied.
*Condition C2: “V1>Vd” and “V2>Vmin” are satisfied.

When the condition C1 is satisfied, the reactive power command unit 44 increases a predetermined amount of lagging reactive power generated by the synchronous machine 1. When the condition C2 is satisfied, the reactive power command unit 44 increases a predetermined amount of leading reactive power generated by the synchronous machine 1. When neither of the conditions C1 and C2 are satisfied, the reactive power command unit 44 causes the synchronous machine 1 to maintain the current reactive power. Here, “increasing the lagging reactive power” means decreasing the leading reactive power when the synchronous machine 1 is generating the leading reactive power at the present time. Similarly, “increasing the leading reactive power” means decreasing the lagging reactive power when the synchronous machine 1 is generating the lagging reactive power at the present time.

Accordingly, the reactive power is adjusted as necessary in each sampling period described above, and thus the control device 40 can appropriately control the reactive power generated by the synchronous machine 1. That is, the control device 40 can set both the voltage V1 at the demand point P1 and the voltage V2 at the observation point P2 to appropriate values.

### Second Embodiment

### Configuration of Second Embodiment

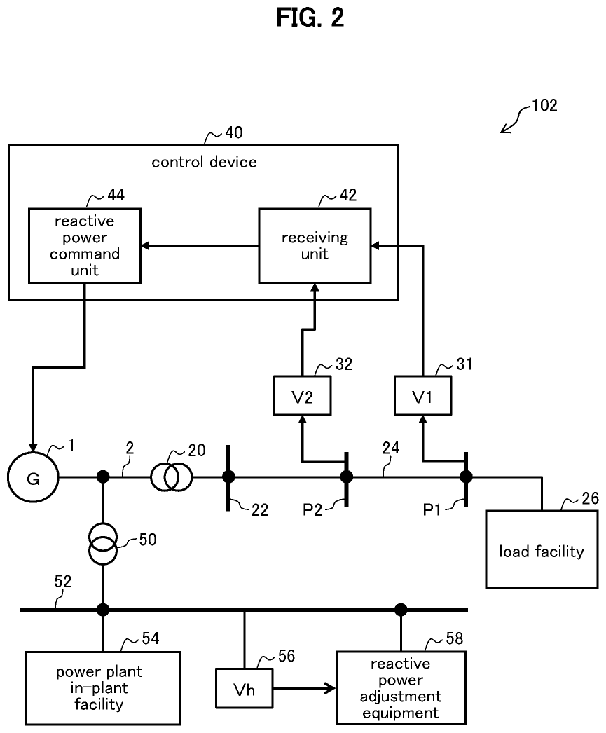

FIG. 2 is a block diagram of a power system 102 according to a second embodiment. In the description of each embodiment, the same reference numerals are given to the portions corresponding to the respective portions of the other embodiments described above, and the description thereof may be omitted.

In FIG. 2, the power system 102 includes all the elements of the power system 100 of the first embodiment (see FIG. 1), and further includes a transformer 50 (i.e., second transformer), an in-plant bus 52, a power plant in-plant facility 54, an in-plant bus voltage sensor 56 (i.e., third voltage sensor), and a reactive power adjustment equipment 58. These components 50 to 58 are facilities provided in the same power plant as of the synchronous machine 1.

The primary winding (no reference numeral) of the transformer 50 is connected to the main circuit 2, and the secondary winding (no reference numeral) is connected to the in-plant bus 52. The power plant in-plant facility 54, the in-plant bus voltage sensor 56, and the reactive power adjustment equipment 58 are connected to the in-plant bus 52. The power plant in-plant facility 54 receives power from the in-plant bus 52 via the transformer 50. The in-plant bus voltage sensor 56 measures a voltage Vh (i.e., third voltage) of the in-plant bus 52. The reactive power adjustment equipment 58 supplies reactive power to the in-plant bus 52 based on the measurement result of the voltage Vh.

The control device 40 sets the voltage V1 at the demand point P1 as a control target as in the first embodiment. Therefore, even if the voltage V2 in the power transmission system 24 is within the allowable range of Vmin to Vmax, a load of voltage fluctuation (i.e., over voltage or low voltage) may occur in the in-plant bus 52. Therefore, the reactive power adjustment equipment 58 in the present embodiment supplies the reactive power of the lagging phase or the leading phase to the in-plant bus 52 so that the voltage Vh of the in-plant bus 52 approaches a predetermined specified value (in other words, falls within a predetermined range).

### Comparative Example

Hereinafter, a comparative example will be described in order to clarify effects of the embodiments.

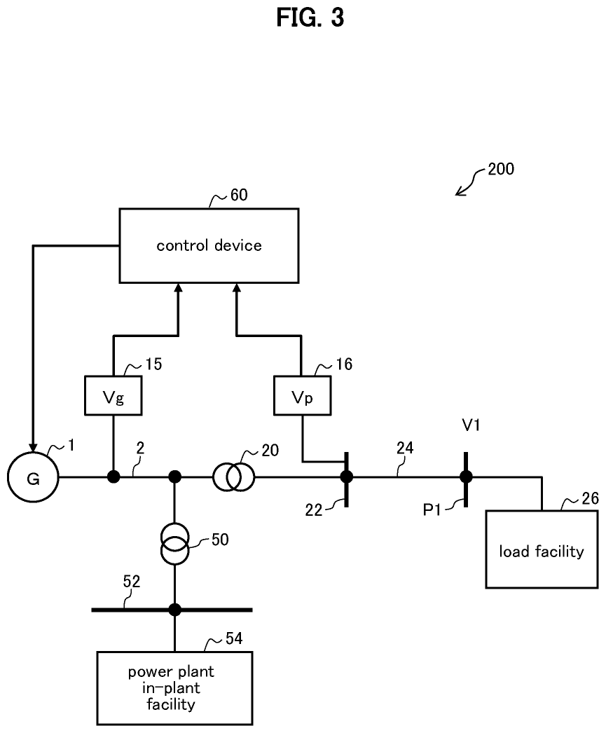

FIG. 3 is a block diagram of a power system 200 according to a comparative example. The power system 200 includes a synchronous machine 1, a main circuit 2, a transformer 20, a switching station 22, a power transmission system 24, a transformer 50, an in-plant bus 52, and a power plant in-plant facility 54. Further, the power transmission system 24 is connected to a load facility 26 at the demand point P1. Contents of these elements are the same as those of the first and second embodiments.

The power system 200 further includes voltage sensors 15 and 16 and a control device 60. The voltage sensor 15 measures a voltage Vg in the vicinity of the synchronous machine 1. The voltage sensor 16 measures a voltage Vp in the vicinity of the switching station 22. The control device 60 controls a reactive power output by the synchronous machine 11 with the voltages Vg and Vp as control targets, and controls an output voltage of the synchronous machine 11.

In the configuration of FIG. 3, it is assumed that a power generation facility (not shown) using renewable energy is connected to the power transmission system 24 from the switching station 22 to the demand point P1. A voltage at the demand point P1 fluctuates due to power flow or the like by the power generation facility. However, in the configuration of FIG. 3, since the voltage V1 at the demand point P1 is not included in the control target, it is difficult to control the voltage V1 within an appropriate range by the control device 60. In order to control the voltage V1 to be within an appropriate range, it is necessary to insert a voltage compensation device (not shown) at various positions in the power transmission system 24. In addition, when the voltage fluctuation in the power transmission system 24 increases, many voltage compensation devices are required, and thus the facility cost in the power transmission system 24 also increases.

### Modifications

The present disclosure is not limited to the above-described embodiments, and various modifications are applicable. The above-described embodiments are examples for easily understanding the present disclosure. The present disclosure is not necessarily limited to those including all the configurations described above. In addition, a part of configurations in an embodiment can be replaced with those of other embodiments, and the configurations of other embodiments can be added to those of an embodiment. In addition, a part of the configurations of each embodiment can be deleted, another configuration can be added, or the configurations can be replaced with another configuration. In addition, control lines and information lines illustrated in the drawings are those considered to be necessary for description, and all control lines and information lines necessary for a product are not necessarily illustrated. In practice, it may be considered that almost all the configurations are connected to each other. Possible modifications of the above embodiments are, for example, as follows.

(1) According to each of the above-described embodiments, whether or not the conditions C1 and C2 are satisfied is determined according to the voltage V2 at the observation point P2 in addition to the voltage V1 at the demand point P1. However, in a case where the power transmission system 24 is relatively short, measurement of the voltage V2 may be omitted. In this case, the condition C1 is “V1<Vd is satisfied”, and the condition C2 is “V1>Vd is satisfied”.

(2) According to each of the above-described embodiments, the synchronous machine 1 is applied as a specific example of a power generation source. However, the power generation source is not limited to the synchronous machine 1, and may be any device that can control the reactive power to be output.

### Effects of Embodiments

As described above, according to the above-described embodiments, the reactive power control device (40) includes the receiving unit 42 and the reactive power command unit 44. The receiving unit 42 receives the first voltage (V1) at the demand point P1 at which power is received from the first voltage sensor (31). The reactive power command unit commands the power generation source (1) that outputs AC power to the demand point P1 to generate reactive power based on the first voltage (V1) via the power transmission system 24. This configuration makes it possible to appropriately control the reactive power output by the power generation source (1) based on the first voltage (V1) at the demand point P1.

More preferably, the receiving unit 42 further receives a second voltage (V2) at an observation point P2 located between the power generation source (1) and the demand point P1 from the second voltage sensor (32). The reactive power command unit 44 commands the power generation source (1) to generate the reactive power based on the first voltage (V1) and the second voltage (V2). This configuration makes it possible to more appropriately control the reactive power output by the power generation source (1) based on the second voltage (V2) at the observation point P2 in addition to the first voltage (V1) at the demand point P1.

Further, more preferably, the reactive power command unit 44 has a function of determining whether or not a first condition (C1) that the first voltage (V1) is lower than a predetermined first level (Vd) and the second voltage (V2) is lower than a predetermined second level (Vmin) is satisfied in each predetermined sampling period; a function of determining whether or not a second condition (C2) that the first voltage (V1) is higher than the first level (Vd) and the second voltage (V2) is higher than a predetermined third level (Vmax) is satisfied in each sampling period; a function of increasing the lagging reactive power generated by the power generation source (1) when the first condition (C1) is satisfied; and a function of increasing the leading reactive power generated by the power generation source (1) when the second condition (C2) is satisfied. This configuration enables the reactive power output from the power generation source (1) to be more appropriately controlled based on the relationship between the first voltage (V1) and the first level (Vd) and the relationship between the second voltage (V2) and the second level (Vmin) or the third level (Vmax).

Further, the power system 102 according to the second embodiment described above is provided in the power plant, and includes the main circuit 2, the second transformer (50), the power plant in-plant facility 54 that receives power via the in-plant bus 52, the third voltage sensor (56) configured to detect the third voltage (Vh) in the in-plant bus 52, and the reactive power adjustment equipment 58 configured to supply reactive power to the in-plant bus 52 so that the third voltage (Vh) falls within a predetermined range. This configuration makes it possible to suppress the third voltage (Vh) applied to the power plant in-plant facility 54 within an appropriate range.

What is claimed is:

1. A reactive power control device comprising:
a receiving unit configured to receive a first voltage at a demand point that receives power from a first voltage sensor;
a reactive power command unit configured to command a power generation source configured to output AC power to the demand point via a power transmission system to generate reactive power based on the first voltage.

2. The reactive power control device according to claim 1, wherein
the receiving unit further includes a function of receiving a second voltage at an observation point located between the power generation source and the demand point from a second voltage sensor, and
the reactive power command unit is configured to command the power generation source to generate reactive power based on the first voltage and the second voltage.

3. The reactive power control device according to claim 2, wherein
the reactive power command unit includes:
a function of determining whether or not a first condition that the first voltage is lower than a predetermined first level and the second voltage is lower than a predetermined second level is satisfied, in each predetermined sampling period;
a function of determining whether or not a second condition that the first voltage is higher than the first level and the second voltage is higher than a predetermined third level is satisfied, in each sampling period;
a function of increasing lagging reactive power generated by the power generation source when the first condition is satisfied;
a function of increasing leading reactive power generated by the power generation source when the second condition is satisfied.

4. A power system comprising:
a power generation source provided in a power plant and configured to output AC power to a demand point via a main circuit, a first transformer, and a power transmission system;
a power plant in-plant facility provided in the power plant and configured to receive power via the main circuit, a second transformer, and an in-plant bus;
a receiving unit configured to receive a first voltage at the demand point from a first voltage sensor;
a reactive power command unit configured to command the power generation source to generate reactive power based on the first voltage;
a third voltage sensor configured to detect a third voltage in the in-plant bus; and
a reactive power adjustment equipment configured to supply reactive power to the in-plant bus so that the third voltage is within a predetermined range.
